(19) United States
(12) Patent Application Publication
(10) Pub. No.: US 2017/0241498 A1
(43) Pub. Date: Aug. 24, 2017

(54) SPRING CONE FOR FACILITATING SPRING INSERTION ONTO SMALL WIRE SIZE

(71) Applicant: CANIMEX INC., Drummondville (CA)

(72) Inventor: Yannick FUNK, Drummondville (CA)

(21) Appl. No.: 15/115,329

(22) PCT Filed: Jan. 29, 2015
(86) PCT No.: PCT/CA2015/050064

§ 371 Date: Jul. 29, 2016

Related U.S. Application Data
(60) Provisional application No. 61/933,065, filed on Jan. 29, 2014.

(51) Int. Cl. F16F 1/12; E05D 13/00

(52) U.S. Cl. CPC F16F 1/125; E05D 13/12; F16F 2238/024; F16F 2232/02; E05D 15/16

(57) ABSTRACT

A plug (1) for use with a counterbalancing system (3) of a cable-operated door (5). The plug (1) includes flange and collar portions (13,15), the flange portion (13) being connectable to a mounting component (7) of the counterbalancing system (3) in order to allow a torque transfer from a torsion spring (9) to the mounting component (7), and the collar portion (15) being configured for winding into a given end (17) of the torsion spring (9), the collar portion (15) having opposite first and second extremities (19,21), and an outer surface (23) extending between these extremities (19,21), the outer surface (23) of the collar portion (15) being provided with a plurality of threads (25) and a plurality of corresponding recesses (27) each being defined between a pair of adjacent threads (25), each recess (27) being configured for receiving therein a single coil segment (11a) of the torsion spring (9), and being further shaped and sized for preventing another coil segment (11b) of the torsion spring (9) from embarking onto said recess (27).

### FIELD OF THE INVENTION

The present invention relates to a spring cone, or simply “cone” (hereinafter referred to also as a “plug”). More particularly, the present invention relates to a spring cone designed in order to ease spring insertion on small wire size of counterbalancing systems and the like.

### BACKGROUND

It is known in the art that most of conventional overhead sectional garage door assemblies use a torsion spring to counterbalance the weight of the garage door. These torsion springs are generally assembled on a stationary cone and on a winding cone.

It is also known that residential torsion springs for garage door usually work by friction fit. When the spring is wounded, its diameter reduces and clamps against the cone. Thus, friction is the only “mechanical” force used to maintain the spring and cone together even when fully under tension. Therefore, the fit between the spring and the cone is very important to avoid slippage of the spring. On one hand, namely on the friction section of the cone, the outside diameter of the cone needs to be bigger than the inside diameter of the spring to create an interference fit and create an adequate friction fit. On the other hand, to ease the insertion of the torsion spring onto the cone, the first section of the cone needs to have a smaller diameter than that of the spring. Normally, a friction fit cone has threads to be able to screw the end of the spring onto the cone.

It is also known that only one spring coil should be inserted per thread on the plug. If more than one coil of the spring is inserted onto one single recess of the cone, the coil of the spring will not sit correctly on the bottom of the recess of the cone, and this might create spring slippage problems and might create distortion of the spring, etc.

Most of the spring manufacturers that assemble the torsion spring onto the cone use a motorized system/device to perform this insertion. It is normally a simple motor with an “on/off” button operated manually by an operator. The difficulty for the operator is to determine when to stop the insertion of the spring onto cone. As mentioned earlier, spring insertion is very important: on one hand, if the spring is not inserted far enough, the friction fit will not hold the torsion torque of the spring and the spring will slip out of the cone, whereas on the other hand, if the spring is inserted too far, the tail of the spring can bump against the wall of the cone which would create distortion of the spring and create shock on the motorized system which can cause premature failure of this motorized system, etc.

The other difficulty with the motorized system is to insert only one spring coil per thread/recess. As soon as system parameters are not ideal, one can easily get two spring coils sitting on the same thread/recess of the spring, which is undesirable, for the reasons mentioned above. This particular drawback tends to occur more frequently and is especially true for torsion springs of small wire size.

Finally, and conversely, if the wire of the spring is too big for the threads of the cone, the friction fit will not be adequate and the spring might slip out of the cone.

The Assignee of the present application has developed various new products and manufacturing processes over the years, particularly in relation to cones, plugs, counterbalancing systems and the like, for which various US utility patents and design patents have been obtained (see some examples given below), the contents of which are incorporated herein by reference: U.S. Pat. Nos. 6,174,575; 6,279,268; 6,378,170; 6,485,006; 6,502,281; 6,681,809; 6,694,673; 6,712,116; 6,907,964; 6,931,810; 6,959,751; 6,986,378; 6,988,527; 7,000,292; 7,000,354; 7,086,441; 7,350,333; 7,441,749; 7,543,625; 7,600,344; D490,685; D520,338; and D524,633.

The Assignee of the present application has also filed various other US patent applications having become public, the contents of which are also incorporated herein by reference: 2002/0117787 A1; 2004/0000109 A1; 2004/0020609 A1; 2005/0006545 A1; 2007/0012410 A1; 2007/0084012 A1; 2007/0204515 A1; 2007/0283525 A1; 2009/0314869 A1; and 2011/0240236 A1.

Nonetheless, despite all of these innovations, there is always a need to continue improving and find better and/or different ways of facilitating the insertion of the spring onto a cone, whether it be a stationary cone and/or a winding cone.

### SUMMARY OF THE INVENTION

An object of the present invention is to provide a plug (i.e. “cone”, etc.) which, by virtue of its design and components, satisfies some of the above-mentioned needs and which is thus an improvement over other related spring plugs and/or winding methods known in the prior art.

In accordance with the present invention, the above object is achieved, as will be easily understood from the present description, with a plug such as the one briefly described herein and such as the one exemplified in the accompanying drawings.

More particularly, according to one aspect of the present invention, there is provided a plug for use with a counterbalancing system of a cable-operated door, in order to operatively connect a corresponding mounting component of the counterbalancing system to a torsion spring door having a plurality of coils, the plug comprising:

flange and collar portions, the flange portion being rigidly affixed to the collar portion, and being connectable to the mounting component of the counterbalancing system in order to allow a torque transfer from the torsion spring to said mounting component, and the collar portion of the plug being configured for winding into a given end of the torsion spring, the collar portion having opposite first and second extremities, and an outer surface extending between said extremities, the outer surface of the collar portion being provided with a plurality of threads and a plurality of corresponding recesses each being defined between a pair of adjacent threads, each recess being configured for receiving therein a single coil segment of the torsion spring, and being further shaped and sized for preventing another coil segment of the torsion spring from embarking onto said recess.

The plug may be a stationary plug or a winding plug.

According to another aspect of the invention, there is also provided a method of manufacturing the above-mentioned plug.

According to yet another aspect of the invention, there is also provided a counterbalancing system provided with the above-mentioned plug.

According to yet another aspect of the invention, there is also provided a method of using the above-mentioned plug and/or counterbalancing system.

According to yet another aspect of the invention, there is also provided a kit with components for assembling the above-mentioned plug and/or counterbalancing system.

According to yet another aspect of the present invention, there is also provided a set of components for interchanging with components of the above-mentioned kit.

According to yet another aspect of the present invention, there is also provided a method of assembling components of the above-mentioned kit and/or set.

According to yet another aspect of the present invention, there is also provided a method of doing business with the above-mentioned plug, counterbalancing system, accessories thereof, kit, set and/or method(s).

The objects, advantages, and other features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIGS. 1-10 are different views of various aspects, components and features of a possible stationary plug according to a preferred embodiment of the present invention.

FIGS. 11-25 are different views of various aspects, components and features of a possible winding plug according to a preferred embodiment of the present invention.

FIG. 26 is another perspective view of the plug shown in FIG. 11, the plug being now shown provided with a pair of setscrews.

FIG. 27 is a top view of what is shown in FIG. 26.

FIG. 28 is a cross-sectional view taken along line XXVIII-XXVIII of what is shown in FIG. 27.

FIG. 29 is a partial perspective view of a cable-operated door having a counterbalancing system provided with at least one stationary plug and at least one winding plug according to a possible embodiment of the present invention.

FIG. 30 is an enlarged view of a portion of what is shown in FIG. 29, and better illustrating cooperation of the winding plug with the torsion spring of the counterbalancing system according to a possible embodiment of the present invention.

FIG. 31 is an enlarged view of another portion of what is shown in FIG. 29, and better illustrating cooperation of the stationary plug with the torsion spring of the counterbalancing system according to a possible embodiment of the present invention.

### DETAILED DESCRIPTION OF PREFERRED EMBODIMENTS OF THE INVENTION

In the following description, the same numerical references refer to similar elements. Furthermore, for sake of simplicity and clarity, namely so as to not unduly burden the figures with several reference numbers, only some figures have been provided with reference numbers, and components and features of the present invention illustrated in other figures can be easily inferred therefrom. The embodiments, geometrical configurations, materials mentioned and/or dimensions shown in the figures are preferred, for exemplification purposes only.

Moreover, although the present invention was primarily designed for use with a counterbalancing spring of a counterbalancing system, preferably a spring of small wire size (ex. with wire size less than 0.225 inches, etc.), it may be used with other objects and/or in other types of applications, as apparent to a person skilled in the art. For this reason, expressions such as “counterbalancing”, “spring”, “small”, “wire”, etc., used herein should not be taken so as to limit the scope of the present invention and include all other kinds of objects and/or applications with which the present invention could be used and may be useful.

Moreover, in the context of the present invention, the expressions “plug”, “cone”, “device”, “system”, “unit”, “assembly”, “product”, as well as any other equivalent expressions and/or compound words thereof, may be used interchangeably. The same applies for any other mutually equivalent expressions, such as “plug” and “cone”, as well as “winding”, “turning” and “forcing”, or even “wire” and “coil”, for example, as also apparent to a person skilled in the art.

Furthermore, in the context of the present description, it will be considered that all elongated objects will have an implicit “longitudinal axis” or “centerline”, such as the longitudinal axis of shaft for example, or the centerline of a plug or a cone, for example, and that expressions such as “connected” and “connectable”, or “mounted” and “mountable”, may be interchangeable, in that the present invention also relates to a kit with corresponding components for assembling a resulting fully assembled and operational counterbalancing system provided with the present plug (and/or a resulting door assembly including the same).

In addition, although the preferred embodiments of the present invention as illustrated in the accompanying drawings comprise various components, and although the preferred embodiments of the plug (and/or portions thereof, such as the abutment wall, for example) and corresponding parts as shown consist of certain geometrical configurations as explained and illustrated herein, not all of these components and geometries are essential to the invention and thus should not be taken in their restrictive sense, i.e. should not be taken so as to limit the scope of the present invention. It is to be understood, as also apparent to a person skilled in the art, that other suitable components and cooperation thereinbetween, as well as other suitable geometrical configurations may be used for plug (and/or portions thereof, such as the abutment wall, for example) and corresponding parts according to the present invention, as will be briefly explained herein and as can be easily inferred herefrom by a person skilled in the art, without departing from the scope of the present invention.

### LIST OF NUMERICAL REFERENCES FOR SOME OF THE CORRESPONDING POSSIBLE COMPONENTS ILLUSTRATED IN THE ACCOMPANYING DRAWINGS

1. plug
1a. stationary plug
1b. winding plug
3. counterbalancing system
5. door (ex. garage door, etc.)
7. mounting component
9. torsion spring
11. coil (of torsion spring)
11a. first or “single” coil segment
11b. second or “another” coil segment
11c. given coil segment
13. flange portion
15. collar portion
17. end (of torsion spring)
19 first extremity (of collar portion)
21. second extremity (of collar portion)
23. outer surface (of collar portion)
25. thread
25a. thread (on one side of the plug)
25b. thread (on other side of the plug)
27. recess
27a. recess (on one side of the plug)
27b. recess (on other side of the plug)
29. thread pitch
31. edge (of thread)
33. abutment wall
35. spring tail (of torsion spring)
37. edge (of abutment wall)
39. width (of abutment wall)
41. corner edge (of abutment wall)
43. radius of curvature (of corner edge)
45 side (of abutment wall)
47. length (of abutment wall)
49. one side (or “first” side) (of collar portion)
51. other side (or “second” side) (of collar portion)
53. complementary recess
55. longitudinal axis (of plug)
57. bottom rim portion (of plug)
57a. bottom rim portion (on one side of the plug)
57b. bottom rim portion (on other side of the plug)
59. distal extremity (of thread)
59a. distal extremity (of thread on one side of the plug)
59b. distal extremity (of thread on other side of the plug)
61. tip (of distal extremity of thread)
61a. tip (on one side of the plug)
61b. tip (on other side of the plug)
63. passageway
65. delimiting axis
67. distance (between tip and delimiting axis)
67a. distance (between tip and delimiting axis on one side)
67b. distance (between tip and delimiting axis on one side)
69. distance (between 1^{st} recess on one side and 1^{st} recess on other side)
71 distance (between 2^{nd} recess on one side and 2^{nd} recess on other side)
73. distance (between 3^{rd} recess on one side and 3^{rd} recess on other side)
75. distance (between 4^{th} recess on one side and 4^{th} recess on other side)
77. distance (between 5^{th} recess on one side and 5^{th} recess on other side)
79. inner diameter (of plug)
   79min. minimum inner diameter (of plug)
   79max. maximum inner diameter (of plug)
81. outer diameter (of plug)
   81min. minimum outer diameter (of plug)
   81max. maximum outer diameter (of plug)
83. wall thickness (of collar portion)
85. length (of plug)
87. mounting flange (of plug)
89. tip-to-tip span (of the mounting flanges)
91. through-hole (of mounting flange)
93. inner diameter (of through-hole)
95. center-to-center span (of the through-holes)
97. setscrew

Broadly described, and as better exemplified in the accompanying drawings, the present invention relates to a spring cone in order to ease spring insertion on small wire size (ex. with wire size below about 0.225 inches, etc.) of counterbalancing systems and the like, in a simpler, easier, faster, more effective and/or more reliable manner.

According to one general aspect of the present system, there is provided a plug (1) for use with a counterbalancing system (3) of a cable-operated door (5), in order to operatively connect a corresponding mounting component (7) of the counterbalancing system (3) to a torsion spring door (9) having a plurality of coils (11). The plug (1) comprises flange and collar portions (13,15), the flange portion (13) being rigidly affixed to the collar portion (15), and being connectable to the mounting component (7) of the counterbalancing system (3) in order to allow a torque transfer from the torsion spring (9) to said mounting component (7), and the collar portion (15) of the plug (1) being configured for winding into a given end (17) of the torsion spring (9), the collar portion (15) having opposite first and second extremities (19,21), and an outer surface (23) extending between said extremities (19,21), the outer surface (23) of the collar portion (15) being provided with a plurality of threads (25) and a plurality of corresponding recesses (27) each being defined between a pair of adjacent threads (25), each recess (27) being configured for receiving therein a single coil segment (11a) of the torsion spring (9), and being further shaped and sized for preventing another coil segment (11b) of the torsion spring (9) from embarking onto said recess (27).

A thread pitch (29) is defined between neighboring threads (25), and according to a possible embodiment, the thread pitch (29) of the plug (1) is between about 0.20 and 0.25 inches, and more particularly, is about 0.215 inches. Each thread (25) of the collar portion (15) may include an edge (31) having a radius of curvature of about 0.015 inches, for example. The above-mentioned range and specific value of thread pitch (29) is particularly advantageous for preventing overlapping of spring coils (11), especially when used for wire sizes less than about 0.225 inches.

According to another aspect of the present system, the plug (1) comprises an abutment wall (33) disposed between the flange and collar portions (13,15), for abutting against a spring tail (35) of the torsion spring (9) and for preventing said spring tail (35) from embarking onto the flange portion (13).

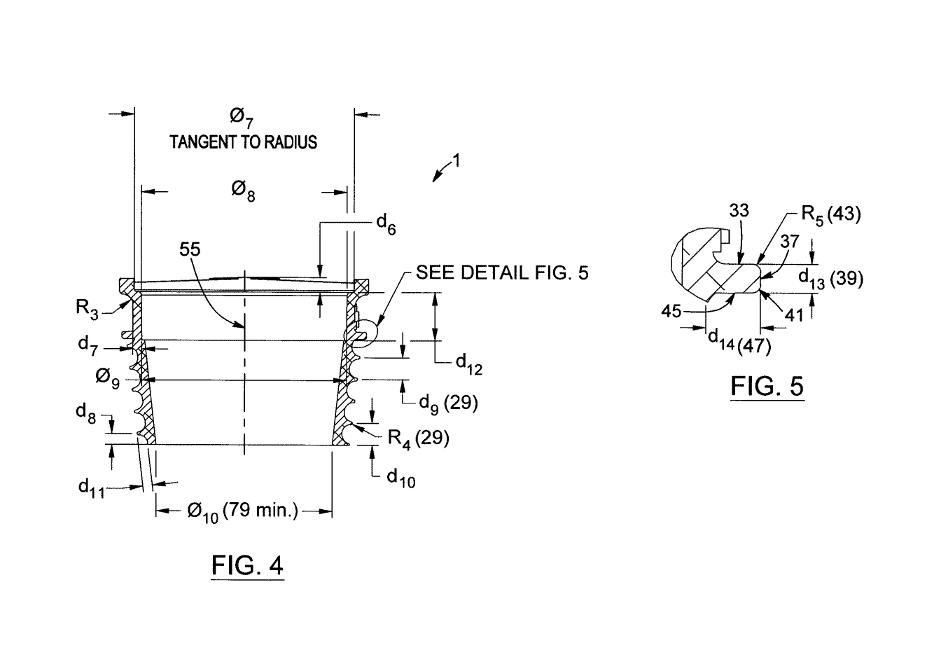

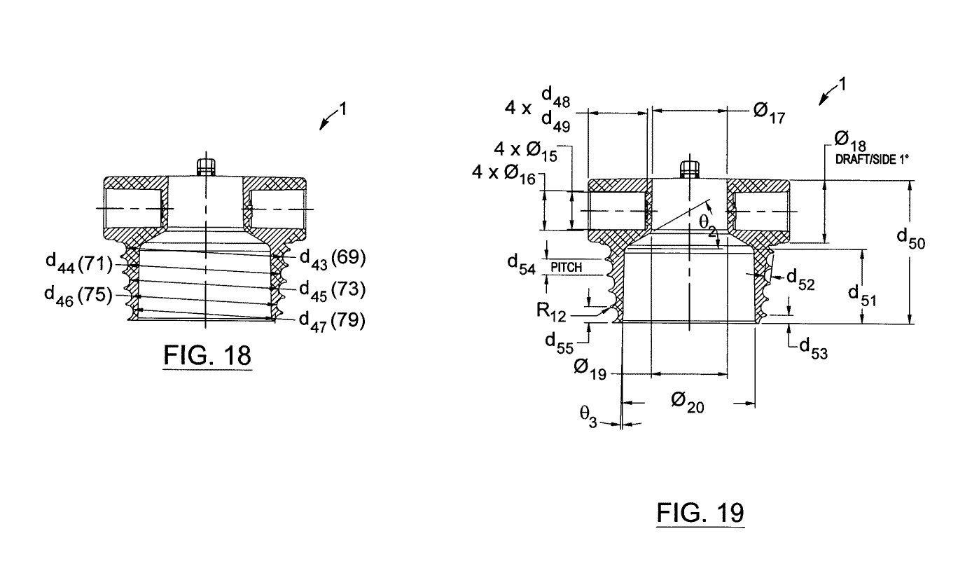

As can be easily understood when referring to FIGS. 4, 5, 6, 9, 13, 14, 17, 18, 19 and 28, the abutment wall (33) can be advantageously positioned, shaped and sized about the plug (1) so that an edge (37) of said abutment wall (33) extends beyond a half-point of the diameter of a given coil segment (11c), which may be insertable into a corresponding recess (27), such as the one most proximate to the flange portion (13), for example.

The abutment wall (33) may extend radially outwardly from the plug (1), and according to a possible given embodiment, as shown in FIGS. 5 and 17 for example, the abutment wall (33) has a substantially rectangular cross-sectional profile, with a width (39) of about 0.070 inches, and a pair of corner edges (41) each having a radius of curvature (43) of about 0.020 inches. The abutment wall (33) may also have a side (45) facing the collar portion (15) and having a length (47) of about 0.135 inches, for example.

According to another aspect of the present system, the plug may also comprise a complementary recess (53) provided on the collar portion (15) of the plug (1), adjacent to the abutment wall (33).

Generally speaking, the plug (1) comprises at least n threads (25) and at least n−1 corresponding recesses (27) extending circumferentially about the outer surface (23) of the collar portion (15), and wherein n is equal to or greater than 2.

According to a given embodiment, as shown in the accompanying figures, the plug (1) can comprise at least 5 threads (25) and at least 4 corresponding recesses (27) extending circumferentially about the outer surface (23) of the collar portion (15).

The threads (25) may be continuous threads (25) disposed about the collar portion (15) of the plug (1), in which case, the threads (25) can be positioned, shaped and sized about the collar portion (15) so that the plug (1) is wound into the given end (17) of the torsion spring (9) via clockwise turns, or via anti-clockwise turns.

Alternatively, the threads (25) are discontinuous threads (25) disposed about the collar portion (15) of the plug (1), as exemplified in the accompanying drawings, and according to an optional embodiment, the threads (25) of the collar portion (15) are positioned, shaped and sized so that the plug (1) is wound into the given end (17) of the torsion spring (9) via both clockwise and anti-clockwise turns, in which case, the plug (1) can be referred to as a “universal” plug (1).

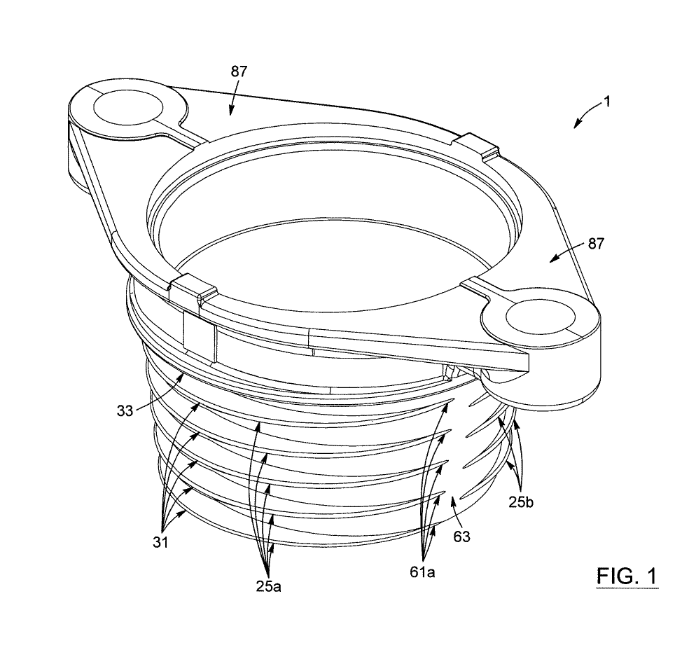

According to another possible embodiment, and as better shown in FIGS. 1, 4, 6, 9, 11, 13, 14, 15, 16, 18, 19, 21, 26 and 28, the plug (1) comprises two different sets of threads (25a,25b), a first set of threads (25a) disposed on one side (49) of the collar portion (15), and a second set of threads (25b) disposed on another opposite side (51) of the collar portion (15).

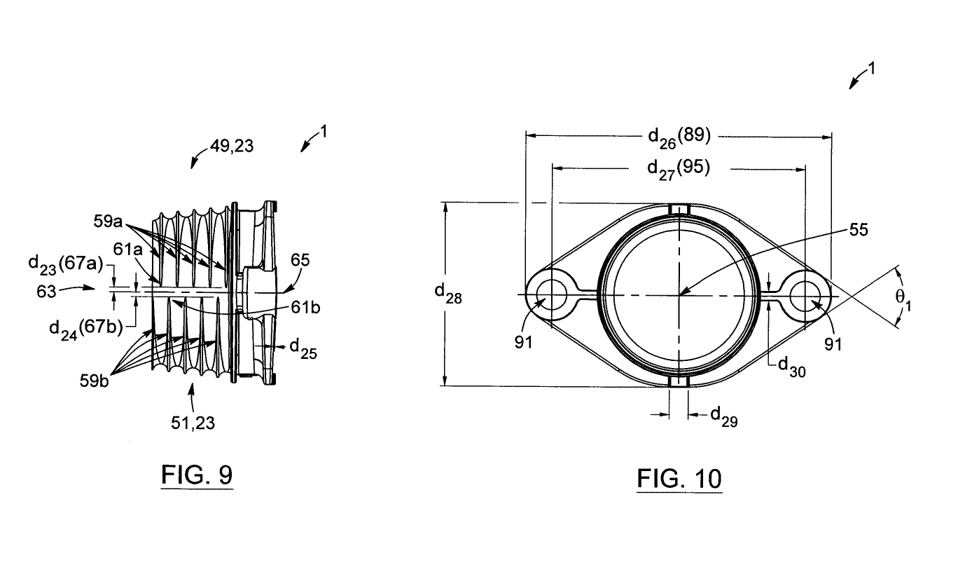

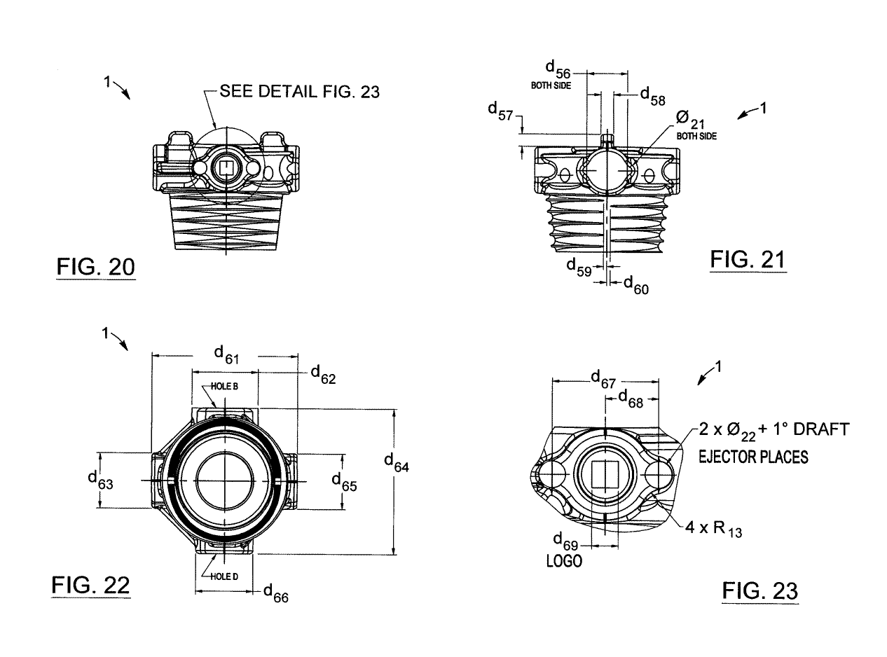

As better shown in FIGS. 9 and 21, the first set of threads (25a) may be offset along a longitudinal axis (55) of the plug (1) with respect to the second set of threads (25b), in which case, each thread (25a) of the first set of threads (25a) on the one side (49) of the collar portion (15) is positioned diametrically opposite to a corresponding recess (27b) of the second set of threads (25b) on the opposite side (51) of the collar portion (15), and each recess (27a) of the first set of threads (25a) on the one side (49) of the collar portion (15) is positioned diametrically opposite to a corresponding thread (25b) of the second set of threads (25b) on the opposite side (51) of the collar portion (15).

According to a given embodiment, as better shown in FIG. 4, for example, a bottommost recess (27ac) of the first set of threads (25a) coincides with a bottom rim portion (57a) of the plug (1) on the one side (49) of the collar portion (15), and a bottommost thread (25bc) of the second set of threads (25b) coincides with another bottom rim portion (57b) of the plug (1) on the opposite side (51) of the collar portion (15).

Referring now back to FIGS. 9 and 21, the first and second sets of threads (25a,25b) may include threads (25) with tapering distal extremities (59). According to one possible embodiment, tips (61) of the distal extremities (59) of each set of threads (25a,25b) are aligned along the collar portion (15) for each set of threads (25a,25b), whereas, according to another possible embodiment, the distal extremities (61a) of the first set of threads (25a) are longitudinally offset along the collar portion (15) with respect to the distal extremities (61b) of the second set of threads (25b), as better shown in FIGS. 9 and 21.

A cleared (unobstructed, etc.) passageway (63) may be defined on the outer surface (23) of the collar portion (15) between the distal extremities (61) of opposite sets of threads (25a,25b), and the passageway (63) may extending along a corresponding delimiting axis (65).

The passageway (63) may be symmetrical, or not, with respect to the delimiting axis (65), but according to one possible embodiment, there is a distance (67a) of about 0.065 inches between the distal extremities (61a) of the first set of threads (25a) and the delimiting axis (65), and thus, in the case of a symmetrical passageway (63), there is a distance (67b) of about 0.065 inches between the distal extremities (61b) of the second set of threads (25b) and the delimiting axis (65).

According to one possible embodiment, the collar portion (15) is a slanted collar portion (15), with the first extremity (19) of the collar portion (15) being greater than the second extremity (21) thereof, and the collar portion (15) of the plug (1) being tapered with a varying inner diameter (79). According to a particularly advantageous embodiment, the collar portion (15) has: a) a maximum outer diameter (81max) of about 2.136 inches; b) a maximum inner diameter (79max) of about 1.966 inches; c) a minimum outer diameter (81min) of about 1.902 inches; d) a minimum inner diameter (79min) of about 1.742 inches; and/or a main wall thickness (83) of about 0.079 inches.

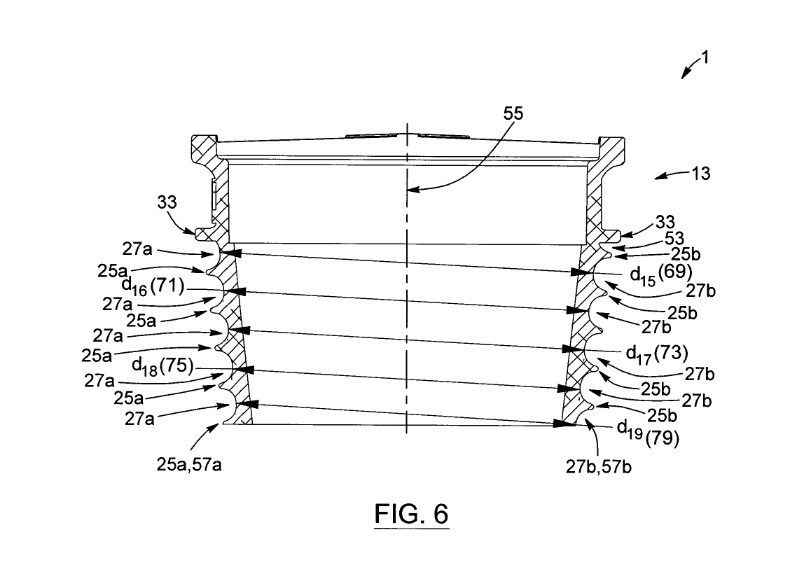

Also according to a particularly advantageous embodiment, and as better shown in FIG. 6 or 18: a) the distance (69) between a first recess (27a) adjacent to the flange portion (13) on one side (49) of the collar portion (15) and a first recess (27b) adjacent to the flange portion (13) on another opposite side (51) of the collar portion (15) is about 2.115 inches; b) the distance (71) between a second recess (27a) adjacent to the first recess (27a) on the one side (49) of the collar portion (15) and a second recess (27b) adjacent to the first recess (27b) on the opposite side (51) of the collar portion (15) is about 2.066 inches; c) the distance (73) between a third recess (27a) adjacent to the second recess (27a) on the one side (49) of the collar portion (15) and a third recess (27b) adjacent to the second recess (27b) on the opposite side (51) of the collar portion (15) is about 2.017 inches; d) the distance (75) between a fourth recess (27a) adjacent to the third recess (27a) on the one side (49) of the collar portion (15) and a fourth recess (27b) adjacent to the third recess (27b) on the opposite side (51) of the collar portion is about 1.968 inches; and/or e) the distance (77) between a fifth recess (27a) adjacent to the fourth recess (27a) on the one side of the collar portion (15) and a fifth recess (27b) adjacent to the fourth recess (27b) on the opposite side (51) of the collar portion (15) is about 1.920 inches.

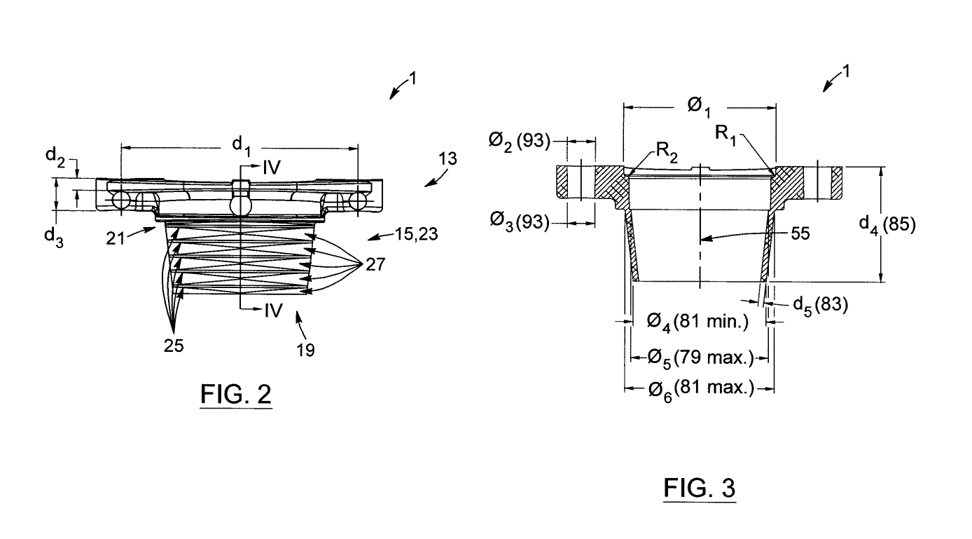

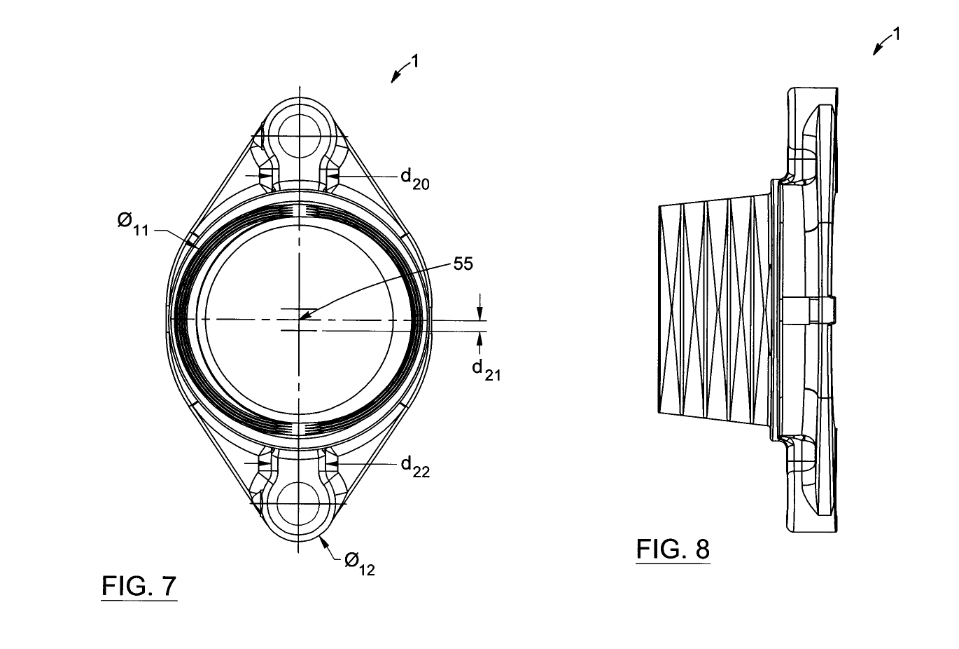

As better shown in FIGS. 1-10 and 31, the plug (1) may be a “stationary” plug (1a), in which case, it may comprise a pair of mounting flanges (87), with the following possible features: a) a length (85) of about 1.648 inches; b) a tip-to-tip span (89) of the mounting flanges (87) of about 4.075 inches; c) each mounting flange (87) being provided with a through-hole (91) having an inner diameter (93) between about 0.393 inches and about 0.404 inches; d) a center-to-center span (95) of the through-holes (91) of about 3.375 inches; e) each mounting flange (87) has first and second sides, said first and second sides being disposed at an angle of about 68 degrees with respect to one another; and/or f) each mounting flange (87) has a rounded tip having a radius of curvature of about 0.700 inches.

According to a possible embodiment, the “stationary plug” (1a) may have the following dimensional features (expressed in “inches”, and where, 1 inch=2.54 centimeters):

TABLE 1
possible dimension(s) for the stationary plug (1a):

| | | |
|---|---|---|
| d1 = 3.375 | d2 = 0.171 | d3 = 0.465 ± 0.010 |
| d4 = 1.648, +0.016, −0.011 | d5 = 0.079 ± 0.010 | d6 = 0.146 ± 0.010 |
| d7 = 0.085 | d8 = 0.108 | d9 = 0.215 |
| d10 = 0.215 | d11 = 0.090 | d12 = 0.475 ± 0.010 |
| d13 = 0.070 | d14 = 0.135 | d15 = 2.115 ± 0.010 |
| d16 = 2.066 ± 0.010 | d17 = 2.017 ± 0.010 | d18 = 1.968 ± 0.010 |
| d19 = 1.920 ± 0.010 | d20 = 0.500, +0.016, −0.011 | d21 = 0.100 |
| d22 = 0.500, +0.016, −0.011 | d23 = 0.065, +0.000, −0.005 | d24 = 0.065, +0.000, −0.005 |
| d25 = 0.015 | d26 = 4.075 | d27 = 3.375 ± 0.013 |
| d28 = 2.450 ± 0.010 | d29 = 0.250 ± 0.010 | d30 = 0.125 ± 0.010 |

TABLE 2
possible diameter(s) for the stationary plug (1a):

| | | |
|---|---|---|
| Ø1 = 2.178 | Ø2 = 0.404 ± 0.005 | Ø3 = 0.393 ± 0.005 |
| Ø4 = 1.902 ± 0.010 | Ø5 = 1.966 | Ø6 = 2.136 |
| Ø7 = 2.162 ± 0.010 | Ø8 = 2.030 ± 0.005 | Ø9 = 2.020 ± 0.005 |
| Ø10 = 1.742 | Ø11 = 2.173 | Ø12 = 0.700, +0.016, −0.011 |

TABLE 3
possible radius(es) of curvature for the stationary plug (1a):

| | | |
|---|---|---|
| R1 = 0.020 | R2 = 0.031 | R3 = 0.125 |
| R4 = 0.015 | R5 = 0.020 | |

TABLE 4
possible angle(s) for the stationary plug (1a):
⊖1 = 68°

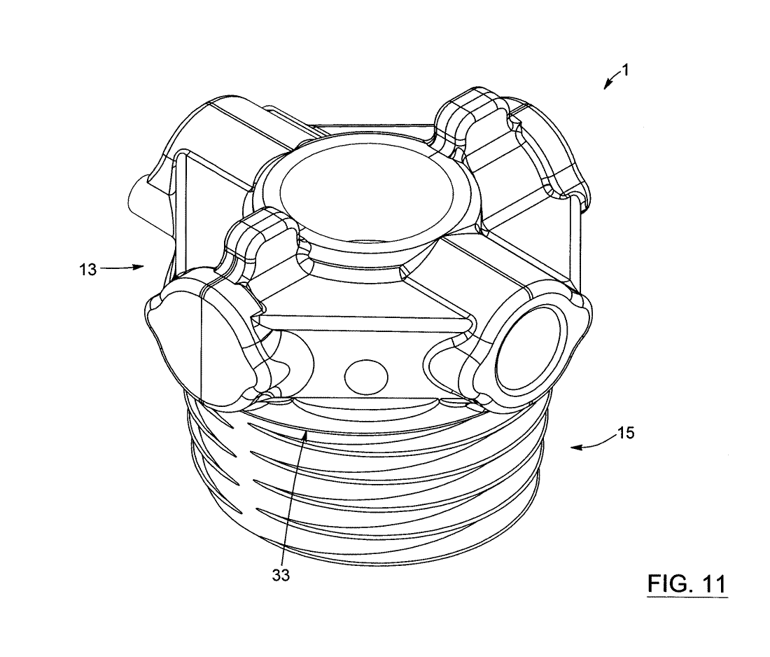

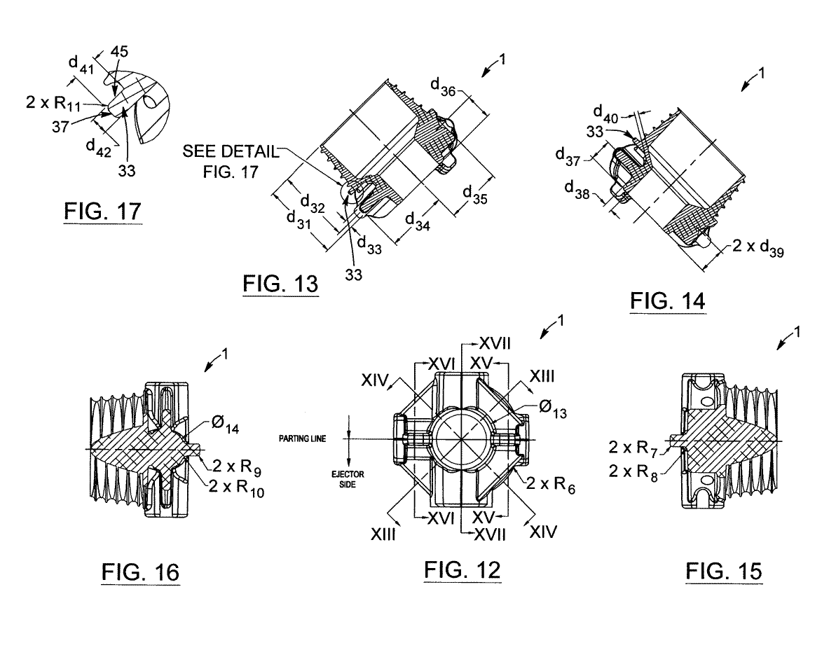

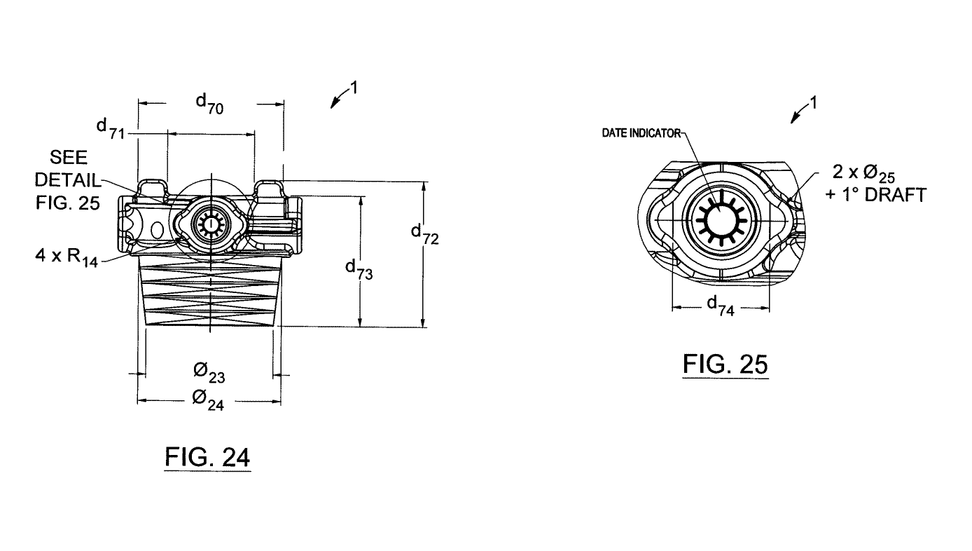

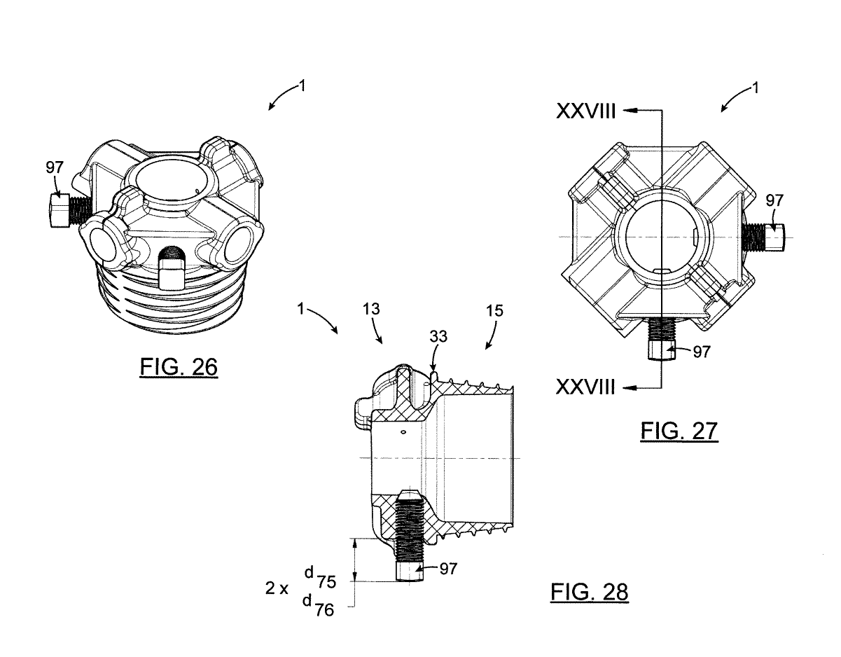

Alternatively, and as better shown in FIGS. 1-28 and 30, the plug (1) may be a “winding” plug (1b), in which case, according to a possible embodiment, the “winding plug” (1b) may have the following dimensional features (expressed in “inches”):

TABLE 5
possible dimension(s) for the winding plug (1b):

| | | |
|---|---|---|
| d31 = 1.602 | d32 = 1.519 | d33 = 0.167 |
| d34 = 1.250 | d35 = 1.125 | d36 = 0.533 |
| d37 = 0.443 | d38 = 0.162 | d39 = 0.533 ± 0.010 |
| d40 = 0.080, +0.016, −0.011 | d41 = 0.135 | d42 = 0.087 |
| d43 = 2.115 + 0.010 | d44 = 2.066 ± 0.010 | d45 = 2.017 ± 0.010 |
| d46 = 1.968 ± 0.010 | d47 = 1.920 ± 0.010 | d48 = 0.830 |
| d49 = 0.750 | d50 = 1.945 | d51 = 1.008, +0.016, −0.011 |
| d52 = 0.090 | d53 = 0.108 | d54 = 0.215 |
| d55 = 0.215 | d56 = 0.770 | d57 = 0.230 ± 0.010 |
| d58 = 0.240 ± 0.010 | d59 = 0.065, +0.000, −0.005 | d60 = 0.065, +0.000, −0.005 |
| d61 = 2.748 ± 0.011 | d62 = 1.250 ± 0.011 | d63 = 1.040 ± 0.011 |
| d64 = 2.730 ± 0.011 | d65 = 1.040 ± 0.011 | d66 = 1.082 ± 0.011 |
| d67 = 1.000 | d68 = 0.500 | d69 = 0.25 |
| d70 = 2.175 ± 0.012 | d71 = 1.300 ± 0.011 | d72 = 2.196, +0.016, −0.011 |
| d73 = 1.968, +0.016, −0.011 | d74 = 0.730 | d75 = 0.0600 |
| d76 = 0.950 | | |

TABLE 6
possible diameter(s) for the winding plug (1b):

| | | |
|---|---|---|
| Ø13 = 1.340, | Ø14 = 0.744 | Ø15 = 0.510 ± 0.005 |
| +0.016, −0.011 | | |
| Ø16 = 0.534 ± 0.010 | Ø17 = 1.015 ± 0.010 | Ø18 = 0.852 |
| Ø19 = 1.033 ± 0.010 | Ø20 = 1.802, | Ø21 = 0.270 |
| | +0.016, −0.011 | |
| Ø22 = 0.250 | Ø23 = 1.902 ± 0.010 | Ø24 = 2.139 |
| Ø25 = 0.350 | | |

TABLE 7
possible radius(es) of curvature for the winding plug (1b):

| | | |
|---|---|---|
| R6 = 0.200 | R7 = 0.045 | R8 = 0.100 |
| R9 = 0.045 | R10 = 0.100 | R11 = 0.030 |
| R12 = 0.015 | R13 = 0.25 | R14 = 0.25 |

TABLE 8
possible angle(s) for the winding plug (1b):

| | |
|---|---|
| ⊖2 = 30° | ⊖3 = 1° |

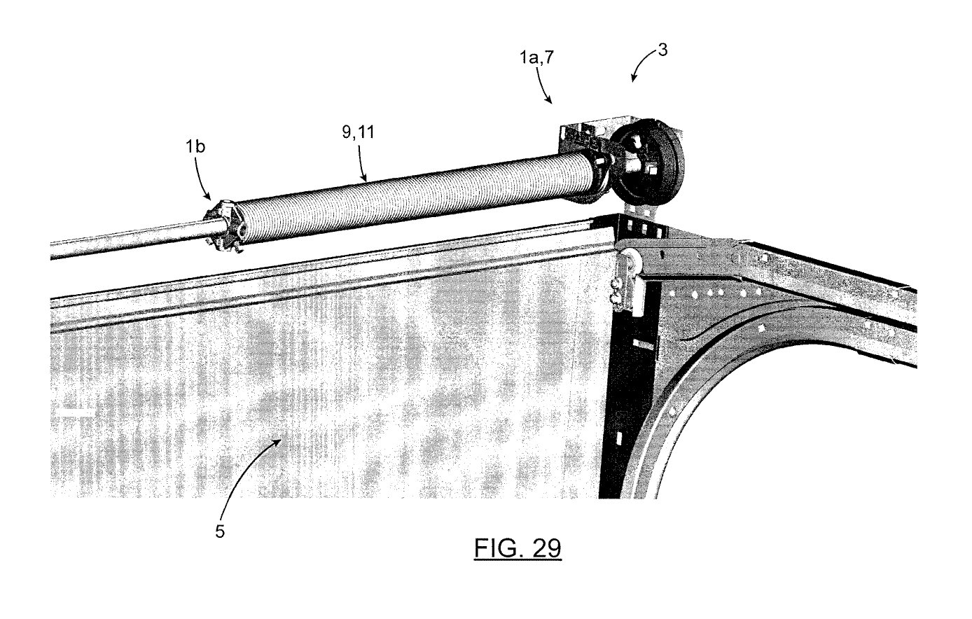

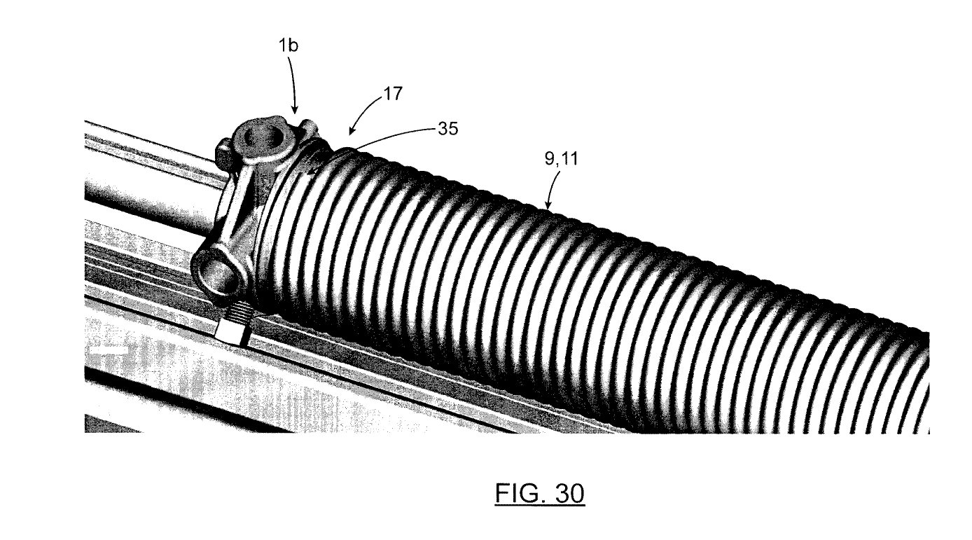

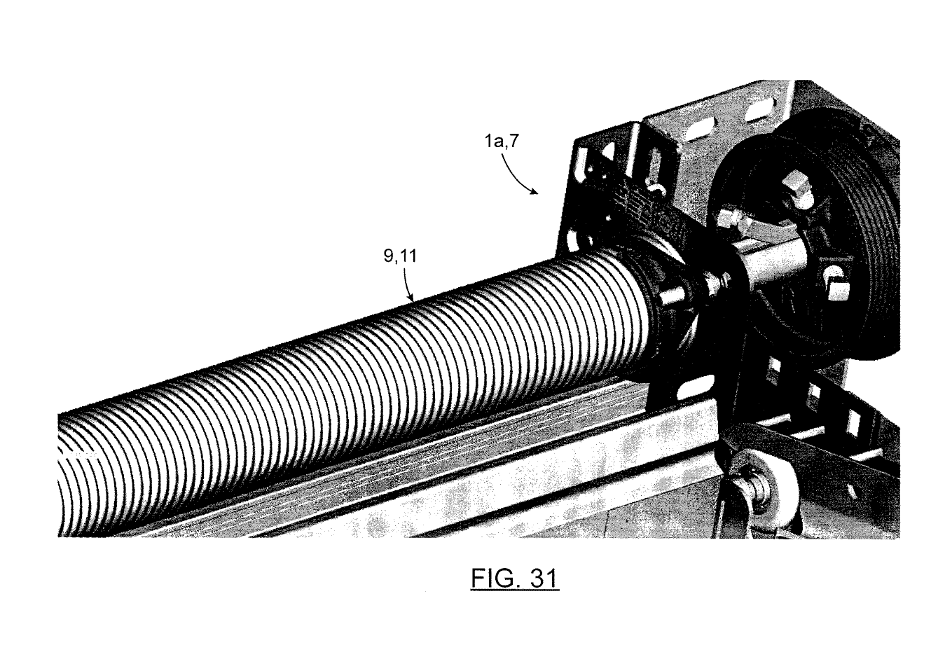

According to another aspect of the present invention, and as exemplified in FIGS. 29-31, there is also provided a counterbalancing system provided with at least one plug (1), whether a “stationary plug” (1a) and/or a “winding plug” (1b), such as the one briefly described herein and such as the one exemplified in the accompanying drawings.

According to yet another aspect of the present invention, there is also a cable-operated door provided with at least one plug (1), whether a “stationary plug” (1a) and/or a “winding plug” (1b), such as the one briefly described herein and such as the one exemplified in the accompanying drawings.

Having described some of the optional components and features of the present plug (1), some of the potential benefits of the use of the present invention will now be described.

Namely, the thread pitch (29) of the plug (1) has been optimized and a full round abutment wall (33) has been added just after the end of thread section of the plug (1). Among the various resulting advantages thereof, the abutment wall (33) can act, for example, as a visual aid for the operator. With this visual aid, it is easier to determine if the torsion spring (9) is well inserted. Indeed, the abutment wall (33) is intended to prevent the tail (35) of the spring (9) to be able to bump against a non-parallel surface of the plug (1). The abutment wall (33) and the particular profile thereof enables namely to wedge smoothly and gradually the tail (35) of the torsion spring (11) against the adjacent wire of the spring (9), thereby preventing the distortion of the spring (9) and preventing shock to the motorized system.

Also, with the optimized pitch for the threads (25), it is not possible for small spring wire size to overlap even near the new abutment wall (33) having been incorporated into the plug (1). Tests carried out by the Applicant have determined that diameter of the coils (11) of the spring (9) need to be “not smaller” than 75% of the pitch (29) of the threads (25) of the plug (1) to ease the insertion.

With the abutment wall (33) and special shape of the threads (25), the bigger wire does not sit on the bottom of the threads (25) (i.e. of the corresponding recesses (27)) and make it obvious that the spring wire size is too big for the plug (1).

It is worth mentioning that several modifications could be made to the present spring plug (1) and corresponding abutment wall(s) (33) (i.e. flange(s), stopper(s), etc.) without departing from the scope of the present invention. For example, the abutment wall (33) does not need to be or extend fully around the entire periphery of the spring plug—indeed, instead of having a continuous circumferential abutment wall (33), it may still functionally operate in a same and/or equivalent manner by extending along a plurality of different discrete sections (i.e. can be one or more section(s) of wall, each being the same or different from one another, etc.). Also, as can be easily understood, and as exemplified in FIGS. 1-10 and 11-28 respectively, the spring plug according to the present invention may be applicable (i.e. used, employed, etc.) for both “stationary” and “winding” plugs.

As may now be better appreciated, the present spring plug (1) with corresponding integrated features and geometrical dispositions, as described herein, is advantageous over the prior art in that it enables to ease spring insertion on small wire size of counterbalancing systems and the like, in a simpler, easier, faster, more effective and/or more reliable manner.

Finally, and as can be easily understood, the present plug (1) and corresponding parts can be made of substantially rigid materials, such as metallic materials, hardened polymers, composite materials, and/or the like, as well as possible combinations thereof, depending on the particular applications for which the plug (1) is intended, and the desired end results.

Of course, and as can be easily understood by a person skilled in the art, the scope of the claims should not be limited by the possible embodiments set forth in the examples, but should be given the broadest interpretation consistent with the description as a whole.

1. A plug (1) for use with a counterbalancing system (3) of a cable-operated door (5), in order to operatively connect a corresponding mounting component (7) of the counterbalancing system (3) to a torsion spring door (9) having a plurality of coils (11), the plug (1) comprising:
flange and collar portions (13,15), the flange portion (13) being rigidly affixed to the collar portion (15), and being connectable to the mounting component (7) of the counterbalancing system (3) in order to allow a torque transfer from the torsion spring (9) to said mounting component (7), and the collar portion (15) of the plug (1) being configured for winding into a given end (17) of the torsion spring (9), the collar portion (15) having opposite first and second extremities (19,21), and an outer surface (23) extending between said extremities (19,21), the outer surface (23) of the collar portion (15) being provided with a plurality of threads (25) and a plurality of corresponding recesses (27) each being defined between a pair of adjacent threads (25), each recess (27) being configured for receiving therein a single coil segment (11a) of the torsion spring (9), and being further shaped and sized for preventing another coil segment (11b) of the torsion spring (9) from embarking onto said recess (27).

2. A plug (1) according to claim 1, wherein a thread pitch (29) is defined between neighboring threads (25), and wherein the thread pitch (29) of the plug (1) is between about 0.20 and 0.25 inches.

3. A plug (1) according to claim 2, wherein the thread pitch (29) is about 0.215 inches.

4. A plug (1) according to any one of claims 1-3, wherein each thread (25) of the collar portion (15) includes an edge (31) having a radius of curvature of about 0.015 inches.

5. A plug (1) according to any one of claims 1-4, wherein the plug (1) comprises an abutment wall (33) disposed between the flange and collar portions (13,15), for abutting against a spring tail (35) of the torsion spring (9) and for preventing said spring tail (35) from embarking onto the flange portion (13).

6. A plug (1) according to claim 5, wherein the abutment wall (33) is positioned, shaped and sized about the plug (1) so that an edge (37) of said abutment wall (33) extends beyond a half-point of the diameter of a given coil segment (11c) insertable into a corresponding recess (27).

7. A plug (1) according to claim 5 or 6, wherein the abutment wall (33) extends radially outwardly from the plug (1).

8. A plug (1) according to any one of claims 5-7, wherein the abutment wall (33) has a substantially rectangular cross-sectional profile.

9. A plug (1) according to any one of claims 5-8, wherein the abutment wall (33) has a width (39) of about 0.070 inches.

10. A plug (1) according to any one of claims 5-9, wherein the abutment wall (33) includes a pair of corner edges (41) each having a radius of curvature (43) of about 0.020 inches.

11. A plug (1) according to any one of claims 5-10, wherein the abutment wall (33) has a side (45) facing the collar portion (15) and having a length (47) of about 0.135 inches.

12. A plug (1) according to any one of claims 1-11, wherein a complementary recess (53) is provided on the collar portion (15) of the plug (1), adjacent to the abutment wall (33).

13. A plug (1) according to any one of claims 1-12, wherein the plug (1) comprises at least n threads (25) and at least n−1 corresponding recesses (27) extending circumferentially about the outer surface (23) of the collar portion (15), and wherein n is equal to or greater than 2.

14. A plug (1) according to any one of claims 1-13, wherein the plug (1) comprises at least 5 threads (25) and at least 4 corresponding recesses (27) extending circumferentially about the outer surface (23) of the collar portion (15).

15. A plug (1) according to any one of claims 1-14, wherein the threads (25) are continuous threads (25) disposed about the collar portion (15) of the plug (1).

16. A plug (1) according to any one of claims 1-15, wherein the threads (25) are positioned, shaped and sized about the collar portion (15) so that the plug (1) is wound into the given end (17) of the torsion spring (9) via clockwise turns.

17. A plug (1) according to any one of claims 1-15, wherein the threads (25) are positioned, shaped and sized about the collar portion (15) so that the plug (1) is wound into the given end (17) of the torsion spring (9) via anti-clockwise turns.

18. A plug (1) according to any one of claims 1-14, wherein the threads (25) are discontinuous threads (25) disposed about the collar portion (15) of the plug (1).

19. A plug (1) according to any one of claims 1-18, wherein the threads (25) of the collar portion (15) are positioned, shaped and sized so that the plug (1) is wound into the given end (17) of the torsion spring (9) via both clockwise and anti-clockwise turns.

20. A plug (1) according to any one of claims 1-19, wherein the plug (1) comprises two different sets of threads (25a,25b), a first set of threads (25a) disposed on one side (49) of the collar portion (15), and a second set of threads (25b) disposed on another opposite side (51) of the collar portion (15), the first set of threads (25a) being offset along a longitudinal axis (55) of the plug (1) with respect to the second set of threads (25b).

21. A plug (1) according to claim 20, wherein each thread (25a) of the first set of threads (25a) on the one side (49) of the collar portion (15) is positioned diametrically opposite to a corresponding recess (27b) of the second set of threads (25b) on the opposite side (51) of the collar portion (15).

22. A plug (1) according to claim 20 or 21, wherein each recess (27a) of the first set of threads (25a) on the one side (49) of the collar portion (15) is positioned diametrically opposite to a corresponding thread (25b) of the second set of threads (25b) on the opposite side (51) of the collar portion (15).

23. A plug (1) according to any one of claims 20-22, wherein a bottommost recess (27ac) of the first set of threads (25a) coincides with a bottom rim portion (57a) of the plug (1) on the one side (49) of the collar portion (15), and wherein a bottommost thread (25bc) of the second set of threads (25b) coincides with another bottom rim portion (57b) of the plug (1) on the opposite side (51) of the collar portion (15).

24. A plug according to any one of claims 20-23, wherein the first and second sets of threads (25a,25b) include threads (25) with tapering distal extremities (59).

25. A plug (1) according to claim 24, wherein tips (61) of the distal extremities (59) of each set of threads (25a,25b) are aligned along the collar portion (15) for each set of threads (25a,25b).

26. A plug (1) according to claim 24 or 25, wherein the distal extremities (61a) of the first set of threads (25a) are longitudinally offset along the collar portion (15) with respect to the distal extremities (61b) of the second set of threads (25b).

27. A plug (1) according to any one of claims 24-26, wherein a cleared passageway (63) is defined on the outer surface (23) of the collar portion (15) between the distal extremities (61) of opposite sets of threads (25a,25b), the passageway (63) extending along a corresponding delimiting axis (65).

28. A plug (1) according to claim 27, wherein the passageway (63) is symmetrical with respect to the delimiting axis (65).

29. A plug (1) according to claim 27 or 28, wherein there is a distance (67a) of about 0.065 inches between the distal extremities (61a) of the first set of threads (25a) and the delimiting axis (65).

30. A plug according to any one of claims 27-29, wherein there is a distance (67b) of about 0.065 inches between the distal extremities (61b) of the second set of threads (25b) and the delimiting axis (65).

31. A plug (1) according to any one of claims 1-30, wherein the distance (69) between a first recess (27a) adjacent to the flange portion (13) on one side (49) of the collar portion (15) and a first recess (27b) adjacent to the flange portion (13) on another opposite side (51) of the collar portion (15) is about 2.115 inches.

32. A plug (1) according to claim 31, wherein the distance (71) between a second recess (27a) adjacent to the first recess (27a) on the one side (49) of the collar portion (15) and a second recess (27b) adjacent to the first recess (27b) on the opposite side (51) of the collar portion (15) is about 2.066 inches.

33. A plug (1) according to claim 32, wherein the distance (73) between a third recess (27a) adjacent to the second recess (27a) on the one side (49) of the collar portion (15) and a third recess (27b) adjacent to the second recess (27b) on the opposite side (51) of the collar portion (15) is about 2.017 inches.

34. A plug (1) according to claim 33, wherein the distance (75) between a fourth recess (27a) adjacent to the third recess (27a) on the one side (49) of the collar portion (15) and a fourth recess (27b) adjacent to the third recess (27b) on the opposite side (51) of the collar portion is about 1.968 inches.

35. A plug (1) according to claim 34, wherein the distance (77) between a fifth recess (27a) adjacent to the fourth recess (27a) on the one side of the collar portion (15) and a fifth recess (27b) adjacent to the fourth recess (27b) on the opposite side (51) of the collar portion (15) is about 1.920 inches.

36. A plug (1) according to any one of claims 1-35, wherein the collar portion (15) is a slanted collar portion (15), with the first extremity (19) of the collar portion (15) being greater than the second extremity (21) thereof.

37. A plug (1) according to any one of claims 1-36, wherein the collar portion (15) of the plug (1) is tapered with a varying inner diameter (79).

38. A plug (1) according to any one of claims 1-37, wherein the collar portion (15) has a maximum outer diameter (81max) of about 2.136 inches.

39. A plug (1) according to any one of claims 1-38, wherein the collar portion (15) has a maximum inner diameter (79max) of about 1.966 inches.

40. A plug (1) according to any one of claims 1-39, wherein the collar portion (15) has a minimum outer diameter (81min) of about 1.902 inches.

41. A plug (1) according to any one of claims 1-40, wherein the collar portion (15) has a minimum inner diameter (79min) of about 1.742 inches.

42. A plug (1) according to any one of claims 1-41, wherein the collar portion (15) has a main wall thickness (83) of about 0.079 inches.

43. A plug (1) according to any one of claims 1-42, wherein the plug (1) is a stationary plug.

44. A plug (1) according to any one of claims 1-43, wherein the plug (1) has a length (85) of about 1.648 inches.

45. A plug (1) according to any one of claims 1-44, wherein the plug (1) comprises a pair of mounting flanges (87).

46. A plug (1) according to claim 45, wherein a tip-to-tip span (89) of the mounting flanges (87) is about 4.075 inches.

47. A plug (1) according to claim 45 or 46, each mounting flange (87) is provided with a through-hole (91) having an inner diameter (93) between about 0.393 inches and about 0.404 inches.

48. A plug (1) according to claim 47, wherein a center-to-center span (95) of the through-holes (91) is about 3.375 inches.

49. A plug (1) according to any one of claims 45-48, each mounting flange (87) has first and second sides, said first and second sides being disposed at an angle of about 68 degrees with respect to one another.

50. A plug (1) according to any one of claims 45-49, each mounting flange (87) has a rounded tip having a radius of curvature of about 0.700 inches.

51. A plug (1) according to any one of claims 1-42, wherein the plug (1) is a winding plug.

52. A counterbalancing system provided with at least one plug (1) such as the one defined according to any one of claims 1-51.

53. A cable-operated door provided with at least one plug (1) such as the one defined according to any one of claims 1-51.
